(19) United States
(12) Patent Application Publication
(10) Pub. No.: US 2006/0199456 A1
(43) Pub. Date: Sep. 7, 2006

(54) Flexible material and method of manufacturing the flexible material

(76) Inventor: David Stirling Taylor, Accrington (GB)

Correspondence Address: FITCH EVEN TABIN AND FLANNERY, 120 SOUTH LA SALLE STREET, SUITE 1600, CHICAGO, IL, 60603-3406, US

(21) Appl. No.: 11/072,683

(22) Filed: Mar. 4, 2005

(51) Int. Cl. B32B 5/26

(52) U.S. Cl. 442/224; 442/182; 442/185; 442/221; 442/305; 442/306; 442/315; 442/328; 442/370

(57) ABSTRACT

A flexible material which includes small separate and spaced blocks of foam adhesively affixed to a stretchable or elastic fabric and a method of manufacturing such a material is provided. The blocks of foam include a surface which interfaces with the fabric and which surface has an area not greater than 1 square inch. The block of foam are adhesively affixed to the fabric with a thermoplastic adhesive having a melting point of at least about 250° F.

### FIELD

This application relates to a flexible material for use as protective padding, especially for protection of the human body during sports, or other physical activity which exposes the body to injury as well as garments which incorporate the flexible material.

### BACKGROUND

Protective wear and protective material conventionally comprise pads associated with fabric, often a stretch fabric, where the pads and fabric are inserted into pockets or sewn onto the garment or substrate. Often the padding or foam is perforated to permit or improve the wicking of perspiration from the body during strenuous physical activity. U.S. Pat. No. 5,689,836 to Fee et. al. describes such foam padding associated with a stretch garment.

U.S. Pat. No. 6,743,325 to Taylor describes a flexible material where a resilient polymeric foam material, such as closed cell polyethylene, is cut into a plurality of separate blocks where the blocks are adhesively affixed to a flexible material, such as a stretchable or elastic fabric. This flexible material easily conforms to a substrate shape and with the small individual blocks of foam, relatively large areas of fabric are available to permit flexibility and wicking perspiration from the body when the flexible material is part of a garment. The '325 patent to Taylor describes affixing the small blocks of foam to the substrate fabric with a hot melt adhesive, but the problem with such the flexible material of the '325 patent to Taylor is that the material heretofore has not been washable and/or dryable without the foam blocks disassociating from the fabric substrate to which they were adhesively attached. Moreover while the foam blocks may be welded using heat or ultra sonic energy, using a hot melt adhesive in film form provides significant manufacturing advantages. Hence, providing a flexible material or garment with the advantages of flexibility by virtue of small foam elements with an adhesive, where the adhesive permits washing and drying of the flexible material, would be a very significant commercial advantage.

Neoprene foam has been known to be associated with fabric, and indeed, articles described in U.S. Pat. No. 5,689,836 to Fee et al. were made with neoprene. But these materials were not readily washable and dryable.

### SUMMARY

A flexible material which includes small separate and spaced blocks of foam adhesively affixed to a stretchable or elastic fabric and a method of manufacturing such a material is provided such that the material with the foam blocks will withstand exposure to high temperature water having temperatures as high as 212° F. and washing detergents as well as subsequent drying without becoming adhesively disassociated from a fabric substrate. The foam elements being relatively small as well as separate and spaced apart, facilitates flexing of the flexible material to form one or more curved surfaces and enables the material to flex in all directions without “locking up” or preventing movement in a particular direction. This is a particular advantage the flexible material of the present invention has over prior art arrangements which tend not to exhibit universal flexibility. The foam elements or blocks should not have a surface which interfaces with their fabric substrate which is larger than 1 square inch, and in an important aspect, the surface areas which interface with the fabric substrate should not have a surface area greater than one half square inch, and preferably not greater than about 0.3 square inch.

The fact that the elements are relatively small, however, make them difficult to adhesively affix to the substrate fabric. In this connection, an adhesive has been found which will not only securely mounts the small foam blocks to the substrate fabric, but also will permit the washing and drying of the flexible material with the blocks adhesively affixed thereto. This adhesive is a thermoplastic adhesive based upon ethyl vinyl acetate and/or polyethylene, and is fire resistant. Polyethylene is an addition polymer of ethylene or may be an addition ethylene/α-olefin interpolymer which is predominately ethylene derived units and where the comonomer (α-olefin) of ethylene is a C3 to C20 α-olefin. In one aspect the adhesive is fire resistant and contains brominated hydrocarbons and less than 25 weight percent di-antimonytrioxide. In an important aspect, the adhesive has a melting point of at least 250° F., and in and important aspect has a melting range of from 250 to 265° F. In an another aspect, the adhesive has a melt flow index (190° C./21.1 N) of at least 2, preferably 3 and generally is in the range of from 3 to 5 g/10 minutes (under test DIN 53735). In another aspect, the adhesive has a washing resistance of at least about 85° F., preferably about 140° F. using test DIN 53920. The adhesive also may have a heat resistance of at least 200° F., and in general has a heat resistance of from 210° F. or more, such as 230° F. The adhesive also has a minimum bond line temperature of about 265° F., preferably about 285° F. In an important aspect, the adhesive is in the form of a film which may be applied to the surfaces of the small separate spaced foam blocks so that they may be heat sealed to the fabric surface or surfaces to which the plurality of foam blocks are bonded.

The elements preferably comprise a resilient foam material, for example a closed cell polyethylene, and could comprise a number of different types of foam or other materials to give desired properties, for example layers of foam of different densities. The elements may be substantially identical, alternatively they can be of different size and shape, for example to fit comfortably part of a wearer's body, or some other article. The elements preferably take the form of blocks. They can be of regular or irregular shape, for example hexagonal or octagonal in cross-section. The elements are preferably evenly distributed on the substrate with a density of between 100 and 8000 elements/m², more preferably between 250 and 8000 elements/m², and still more preferably between 4000 and 6000 elements/m². In one embodiment, the elements comprise cubes of side 12 mm spaced apart by 2 mm. This gives a density of about 5000 cubes/m². This allows the material to flex easily along all directions, an improvement over known quilted protective materials. Also, one type of material can be cut to many different sizes, for example to form protective wear of different sizes, without significantly affecting its ability to flex. This is in contrast to known quilted protective materials wherein due to the size of the foam strips, the size of each strip must be changed to form an article of different size without reducing flexibility.

The substrate for the foam elements is resiliently stretchable or elastic fabric. Suitable fabrics include knitted nylon and polyester fabrics and more particularly those materials comprising elastane. A second layer of a flexible substrate material is preferably bonded over the elements so that they are sandwiched between two layers. In this case, as the first substrate layer is resiliently stretchable or elastic, this helps to prevent puckering of one side of the material when it is flexed. Advantageously, both substrate layers are resiliently stretchable. However, in cases where only a single stretchable substrate layer is provided and the material is to be used in a curved configuration the material is preferably arranged so that the stretchable layer lies on the outside surface of the curve.

In one embodiment of the invention the flexible material may be in clothing or other wear. In this embodiment the fabric of the clothing may form the fabric substrate for the foam elements. In an important aspect of this embodiment, the flexible material with the small blocks adhesively affixed thereto also has the small blocks adhesively affixed to the inner surface of a fabric garment. Preferably fabric serves as top and bottom fabric layers with the inner surface fabric being stitched to the inner surface of the garment and the garment fabric serving as an outer fabric surface bonded to the foam elements. In any event the flexible material is particularly suitable for incorporation into protective clothing and wear, for example where the garment has shoulder pads, knee pads, shin pads, hip pads, arm bands, head-guards, and vests and where the garment should be washable. It will be appreciated that in these garments the blocks are provided where required and omitted from certain areas of the garment. For example, in a headguard no blocks need be positioned in the ear-flaps of the guard.

The flexible material could also be in furniture or upholstery and can be particularly useful when used with wheelchairs and hospital beds where washing and drying of the material is especially useful. Spaced part elements can help to reduce the incidence of bed sores. As the material is resilient, it comprises a cushioning medium for items such as saddles. Where the material comprises a foam layer, this provides it with good thermally insulating properties and it can be usefully incorporated into, or used to form wet suits. A foam layer can also render the material buoyant in water, in which case it can be usefully used in or to form buoyancy vests, life jackets and swimming aids. When used as a swimming aid, for example, the material can be incorporated in swimming costumes as an aid to the buoyancy of the wearer. It is possible in this case to arrange for the foam blocks to be progressively removable from the costume as the confidence and skill or the trainee swimmer increases.

Preferably, at least said one side of the elements are coated with the hot-melt adhesive which is the form of a film prior to being cut into the separate elements. Alternatively or in addition, the side of the substrate adjacent one side of the foam elements is coated with the hot-melt adhesive. A sheet of hot-melt film may also be interposed between said one side of the elements and the substrate to provide the adhesive layer.

The resilient sheet is cut into a plurality of separate elements using a cutter which acts as the jig after cutting through the resilient material to hold the elements in place while the substrate layer is applied thereto. The cutter is adapted so that said one side of each, now cut, element are made to stand proud of the surface of the cutter grid. The sheet material may spring back slightly after cutting to accomplish this. Alternatively, ejectors, may provided to achieve this effect.

In one embodiment of the method, a sheet of a resilient material is provided with both sides of the sheet is coated with a hot melt adhesive. Preferably, the hot melt adhesive is a thin film which also is cut with the foam sheet. The foam sheet with the film sheet of adhesive is placed, adhesive side up, over a cutter grid arranged to cut the sheet into a plurality of elements, for example squares. The foam sheet is pressed down onto the cutter to cut through the sheet. Excess material from between the elements is then removed. A resiliently stretchable substrate is placed over the, now cut, sheet and heated to activate the adhesive to join the elements to the substrate. The substrate is then lifted away from the cutter, taking the elements with it. The substrate with the foam elements then is heated, and optionally stitched into a garment.

The cutter grid can act as a jig, holding the elements in placed while the substrate layer is applied. If the flexible material is to be cut into large pieces, in particular large irregularly shaped pieces, then these pieces may be assembled into a specially constructed jig to hold them into place before application of the substrate. Conveniently, as before the sheet of resilient foam material from which the elements are cut has an adhesive layer applied to one or both surfaces prior to the cutting process.

In another aspect, garments that include the foam elements stitched into the garment may be machine washed in water having a temperature of up to about 140° F. For about 15 minutes and then dried in a dryer having a temperature from about 140° F. up to about 200° F. for about 40 minutes. Garments may be washed and dried more than about 50 times without detachment of the foam elements from the fabric.

### BRIEF DESCRIPTION OF THE DRAWINGS

Embodiments of the various aspects of the invention will now be described by way of example with reference to the accompanying drawings.

FIG. 1 is an enlarged perspective view of part piece of flexible material according to the invention.

FIG. 2 is a plan view of a cutter grid.

FIGS. 3 to 5 are vertical cross-sectional views of apparatus used in the manufacture of material as shown in FIG. 1 at various stages respectively throughout the manufacturing process.

FIG. 6 is a cross-sectional view through another embodiment of a flexible material according to the invention.

### DETAILED DESCRIPTION

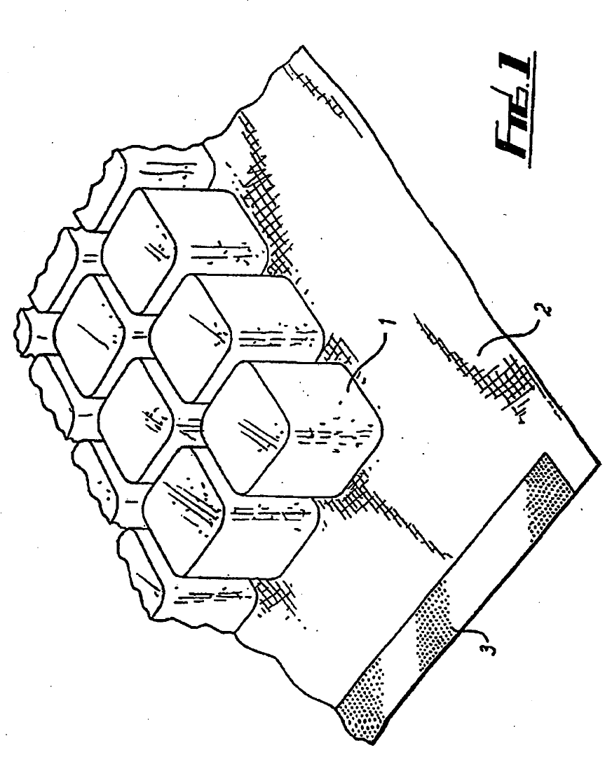

Referring to FIG. 1, the flexible material comprises a plurality of cubes 1 of a resilient closed-cell polyethylene foam, of side approximately 12 mm and with corners of radius approximately 2.5 mm, joined with a hot melt adhesive to a fabric substrate 2. The cubes 1 are evenly arranged, each cube being spaced from adjacent cubes by approximately 2 mm. The fabric 2 is a resiliently stretchable knitted fabric, preferably one comprising polyester or elastic fibers. The stretchable fabric used in connection with the invention may be made of synthetic fabric which is readily stretchable and expandable, preferably comprising expandable nylon/SPANDEX warp knit fabric treated with an INTERA process available from Intera Company, Limited. The treated fabric is available from Darlington company located in Augusta, Ga. In describing characteristics of the preferred treated fabric, the fabric is said to have “four-way stretch,” being capable of substantial stretching in different coplanar directions (e.g., perpendicular or other nonparallel directions taken along the plane of the fabric). While most fabrics “stretch” to some extent, the fabric from which the trousers and intermediate panel are formed has a much greater extent of stretching. For example, certain “non-stretch” fabrics may expand on the order of 10% to 20% when placed under substantial tension, oftentimes greater than that experienced under normal wearing conditions. The present invention, however, contemplates fabric which readily stretches 50% to 200% when tensioned under normal wearing conditions. The present invention also contemplates fabric having so-called “two-way” stretch, i.e., stretch in opposite (parallel) directions along a common direction line. As understood, so-called “four-way stretch” fabrics are typically made of artificial fibers woven with a warp knit and so-called “two-way stretch” fabrics are typically made of artificial fibers woven with a circular knit.

A margin of fabric 2 is provided around the periphery of the cubes 1. Along the edges of the fabric at opposite ends respectively there may be strips 3 of VELCRO™ or excess fabric to accomplish stitching, only one of which is shown.

FIG. 2 shows a plan view of a cutter used for manufacturing the material of FIG. 1. The cutter comprises blades defining a plurality of squares of 12 mm side with corners of radius 2.5 mm.

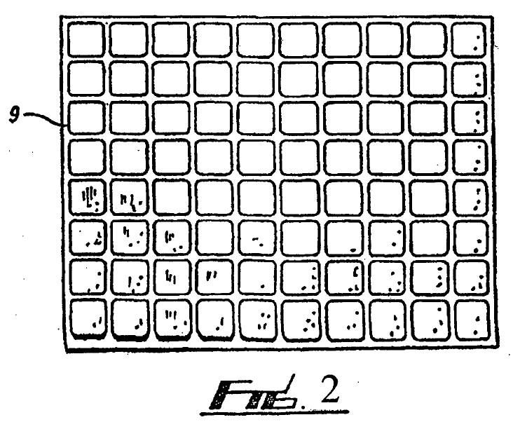

FIGS. 3 to 5 are vertical cross-sectional views of apparatus at various stages respectively throughout the manufacture of the flexible material shown in FIG. 1. Referring to these figures, one side of a 12 mm thick layer of closed cell polyethylene foam 10 is coated with a hot melt adhesive 11. The foam 10 is then placed onto a cutter 12, of the type shown in FIG. 2, and pressed down with a press 13 so that the cutter 12 cuts through the foam 10 to form a plurality of separate cubes. The press is then removed, whereupon owing to its resilient nature, the foam will tend to spring back slightly so that the exposed surface of each cube stands proud to lie above the surface of the cutter. Excess material from between the elements is then removed.

Next, as shown in FIG. 4, a layer of fabric is placed over the foam and cutter 12 and a heated platen 15 is brought into contact with the fabric 14. Heat is conducted through the fabric 14 to the foam and activates the adhesive, bonding the fabric 14 to the foam 10. In this arrangement, the cutter grid acts as a jig, holding the foam cubes in position whilst the fabric substrate 14 is applied thereto.

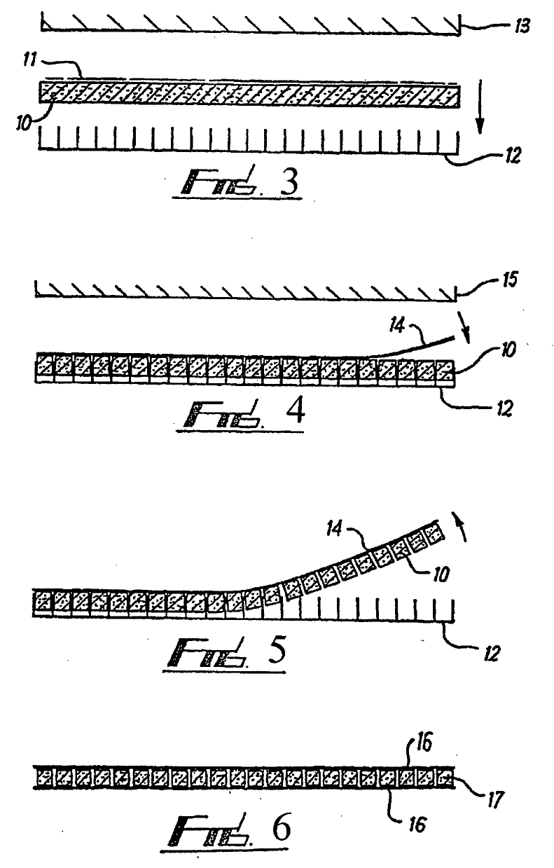

Then, as shown in FIG. 5, the fabric can be lifted away from the cutter taking the foam cubes 10 with it.

In an alternative method, ejectors are disposed in the cutter grid to eject the elements, leaving any waste material behind in the cutters.

If the foam 10 is to be cut into relatively large pieces, in particular large irregularly shaped pieces such as may be suitable for use in an equestrian jacket, then these pieces may be assembled into a specially constructed jig to hold them into place before application of the fabric substrate 14. As described above, the sheet of resilient foam from which the elements are cut will have hot-melt adhesive applied to one or both surfaces prior to the cutting process.

In a further variation, the sheet of resilient material is cut into strips in a first direction using a plurality of rolling cutters. The sheet is cut in a second direction perpendicular to the first to form cubes. The cutters are then moved sideways to cut narrow strips of foam in both directions to space the cubes apart, the narrow strips of foam being stripped away to leave the cubes.

FIG. 6 shows another embodiment of flexible material similar to that shown in FIG. 1, but with a layer of fabric 16 bonded to each of opposite sides of the elements 17. This embodiment may be produced in a similar way to that shown in FIG. 1 except that opposite sides of the foam layer are coated with adhesive and, after the foam cubes bonded to a first layer of fabric have been removed from the cutter, a second layer of fabric is placed over the exposed surface of the elements and pressed with a heated platen to effect a bond.

In other variations to the above methods, the hot-melt adhesive may be applied to the surface the substrate rather or in addition to the sides of the flexible material. Alternatively or in addition, a hot-melt film can be interposed between the elements and the substrate.

Also, heated nip-rollers can be used in place of a heated platen to bond the elements to the substrate, particularly when substrate is bonded to both sides of the elements, which are thereby sandwiched therebetween. This facilitates passage of the material between the rollers prior to activation of the adhesive.

### EXAMPLES OF GARMENTS HAVING THE FLEXIBLE MATERIAL BEING TEST WASHED

Summary of Test Results for Care Label Determination

There was no failure of the adhesive bond between the hexagonal foam pad elements and the shirt and girdle fabrics. The hexagonal foam pads remained securely bonded to the shirt and girdle fabrics and their backing fabric in all laundering methods and temperatures (ranging from 80° F. to 180° F.).
Dimensional change of the shirt and girdle fabric was satisfactory in all laundering methods and temperatures, although the lowest % change was exhibited at the lower wash temperatures.
The girdle's elastic waistband exhibited high shrinkage (relaxed dimension) at the higher wash temperatures although there was no loss of stretch.
Some seams of the shirt and girdle exhibited a higher % shrinkage than the basic fabric in the various laundering methods and temperatures. There was no consistency in these results from method to method (higher in some, lower in others regardless of temperature) but there appears to be no loss of stretch of the seams. (Refer to detailed dimensional change test results).
Colorfastness of the fabric at the higher wash temperatures of 180° F. and 158° F. was unsatisfactory. Color change at 180° F. was severe, the fabric's grey color becoming light green in hue. At 158° F. the grey color changed to a grey-green color. Colorfastness at the lower temperatures was satisfactory.
Colorfastness of the fabric to non-chlorine bleach was satisfactory.

In all launderings methods the shirt and girdle samples maintained good appearance and shape retention. There was no deterioration of seams or fabric and no pilling or fuzziness evident on the fabric surface.

Dimensional Changes in Commercial Laundering
AATCC 96-2001 IIIc

| | |
|---|---|
| Washing & Drying Procedures: | Machine wash in commercial |
| | washer/extractor with horizontal |
| | rotating drum |
| | 4 temperature settings - 180° F., |
| | 158° F., 120° F., 80° F. |
| | Tumble dry low |
| | 4 lb. test load |
| | AATCC Std. Ref. detergent without |
| | optical brighteners |

| | | |
|---|---|---|
| Original | After 3 | Dimensional |
| Measurement | Washes | Changes (%) |

180° F. Commercial Wash

| | | | | |
|---|---|---|---|---|
| Shirt: | | | | |
| Length | center front | 21.875 | 21.250 | −2.9 |
| | center back | 25.750 | 24.875 | −3.4 |
| Width | 6″ up from bottom | 38.500 | 37.750 | −1.9 |
| | bottom hem | 38.750 | 37.000 | −4.5 |
| Armhole | | 18.250 | 18.000 | −1.4 |
| Neck | along seam relaxed | 19.750 | 19.250 | −2.5 |
| Opening | stretched | 44.000 | 44.000 | 0.0 |
| Girdle: | | | | |
| Waist | relaxed | 30.500 | 27.125 | −11.0 |
| | stretched | 51.000 | 50.000 | −2.0 |
| Total Rise | | 27.625 | 27.000 | −2.3 |
| Length | side | 20.625 | 20.250 | −1.8 |
| | inseam | 9.000 | 8.625 | −4.2 |
| Width | crotch | 4.000 | 3.875 | −3.1 |
| | thigh | 19.500 | 19.000 | −2.6 |
| | leg opening | 17.000 | 17.000 | 0.0 |

158° F. Commercial Wash

| | | | | |
|---|---|---|---|---|
| Shirt: | | | | |
| Length | center front | 22.375 | 21.750 | −2.8 |
| | center back | 26.000 | 26.625 | −1.4 |
| Width | 6″ up from bottom | 38.000 | 37.000 | −2.6 |
| | bottom hem | 37.750 | 36.250 | −4.0 |
| Armhole | | 18.250 | 18.000 | −1.4 |
| Neck | along seam relaxed | 20.500 | 20.250 | −1.2 |
| Opening | stretched | 42.000 | 42.000 | 0.0 |
| Girdle: | | | | |
| Waist | relaxed | 30.750 | 27.750 | −9.7 |
| | stretched | 49.000 | 49.000 | 0.0 |
| Total Rise | | 28.125 | 27.500 | −2.2 |
| Length | side | 20.875 | 20.375 | −2.4 |
| | inseam | 9.000 | 8.875 | −1.4 |
| Width | crotch | 4.000 | 3.875 | −3.1 |
| | thigh | 18.500 | 18.250 | −1.4 |
| | leg opening | 16.500 | 15.750 | −4.5 |

120° F. Commercial Wash

| | | | | |
|---|---|---|---|---|
| Shirt: | | | | |
| Length | center front | 21.750 | 21.250 | −2.3 |
| | center back | 26.250 | 25.750 | −1.9 |
| Width | 6″ up from bottom | 37.750 | 36.750 | −2.6 |
| | bottom hem | 38.000 | 36.750 | −3.4 |
| Armhole | | 18.000 | 17.750 | −1.4 |
| Neck | along seam relaxed | 20.000 | 20.000 | 0.0 |
| Opening | stretched | 42.000 | 42.000 | 0.0 |
| Girdle: | | | | |
| Waist | relaxed | 30.500 | 28.250 | −7.4 |
| | stretched | 49.000 | 49.000 | 0.0 |
| Total Rise | | 27.625 | 27.625 | 0.0 |
| Length | side | 20.625 | 20.250 | −1.8 |
| | inseam | 9.000 | 8.750 | −2.8 |
| Width | crotch | 3.875 | 3.875 | 0.0 |
| | thigh | 19.250 | 18.750 | −2.6 |
| | leg opening | 17.000 | 16.750 | −1.5 |

80° F. Commercial Wash

| | | | | |
|---|---|---|---|---|
| Shirt: | | | | |
| Length | center front | 21.625 | 21.375 | −1.7 |
| | center back | 26.250 | 25.750 | −1.9 |
| Width | 6″ up from bottom | 37.750 | 36.500 | −3.3 |
| | bottom hem | 37.750 | 35.500 | −6.0 |
| Armhole | | 18.000 | 18.000 | 0.0 |
| Neck | along seam relaxed | 20.500 | 19.500 | −4.9 |
| Opening | stretched | 44.000 | 44.000 | 0.0 |
| Girdle: | | | | |
| Waist | relaxed | 30.625 | 28.500 | −6.9 |
| | stretched | 50.000 | 50.000 | 0.0 |
| Total Rise | | 28.000 | 27.875 | −0.4 |
| Length | side | 20.500 | 20.250 | −1.2 |
| | inseam | 8.625 | 8.500 | −1.4 |
| Width | crotch | 3.875 | 3.750 | −3.2 |
| | thigh | 19.750 | 19.500 | −1.3 |
| | leg opening | 17.000 | 16.750 | −1.5 |

All measurements are in inches.
(−) Indicates Loss (+) Indicates Gain

Dimensional Changes After Home Laundering
AATCC 150-2003

| | |
|---|---|
| Washing & Drying Procedures | Machine wash, normal cycle |
| | 4 temperature settings - 140° F., |
| | 120° F., 105° F., 80° F. |
| | Tumble dry low |
| | 4 lb. test load |
| | AATCC Std. Ref. detergent without |
| | optical brighteners |

140° F. Commercial Wash

| | | Original | After 3 | Dimensional |
|---|---|---|---|---|
| | | Measurement | Washes | Changes (%) |
| Shirt: | | | | |
| Length | center front | 21.875 | 21.375 | −2.7 |
| | center back | 26.375 | 26.125 | −0.9 |
| Width | 6″ up from bottom | 38.000 | 37.000 | −2.6 |
| | bottom hem | 38.000 | 36.375 | −4.3 |
| Armhole | | 18.000 | 17.750 | −1.4 |
| Neck | along seam relaxed | 19.500 | 19.500 | 0.0 |
| Opening | stretched | 42.000 | 42.000 | 0.0 |
| Girdle: | | | | |
| Waist | relaxed | 30.750 | 28.750 | −6.5 |
| | stretched | 50.000 | 50.000 | 0.0 |
| Total Rise | | 27.625 | 27.625 | 0.0 |
| Length | side | 20.750 | 20.625 | −0.6 |
| | inseam | 9.000 | 8.750 | −2.8 |
| Width | crotch | 4.000 | 3.750 | −6.3 |
| | thigh | 19.000 | 18.500 | −2.6 |
| | leg opening | 16.500 | 16.000 | −3.0 |

All measurements are in inches.
(−) Indicates Loss (+) Indicates Gain

| | | |
|---|---|---|
| Original | After 3 | Dimensional |
| Measurement | Washes | Changes (%) |

120° F. Home Wash

| | | | | |
|---|---|---|---|---|
| Shirt: | | | | |
| Length | center front | 22.375 | 22.125 | −1.1 |
| | center back | 26.250 | 26.000 | −1.0 |
| Width | 6″ up from bottom | 38.250 | 37.500 | 2.0 |
| | bottom hem | 38.250 | 37.250 | −2.6 |
| Armhole | | 18.000 | 18.000 | 0.0 |
| Neck | along seam relaxed | 19.750 | 19.750 | 0.0 |
| Opening | stretched | 42.000 | 42.000 | 0.0 |
| Girdle: | | | | |
| Waist | relaxed | 30.875 | 29.250 | −5.3 |
| stretched | 50.000 | 50.000 | 0.0 | |
| Total Rise | | 28.000 | 27.750 | −0.9 |
| Length | side | 20.625 | 20.625 | 0.0 |
| | inseam | 9.000 | 8.875 | −1.4 |
| Width | crotch | 4.000 | 3.875 | −3.1 |
| | thigh | 18.500 | 18.250 | −1.4 |
| | leg opening | 16.250 | 16.000 | −1.5 |

105° F. Home Wash

| | | | | |
|---|---|---|---|---|
| Shirt: | | | | |
| Length | center front | 21.500 | 21.250 | −1.2 |
| | center back | 25.875 | 25.875 | 0.0 |
| Width | 6″ up from bottom | 38.375 | 37.250 | −2.9 |
| | bottom hem | 38.500 | 37.500 | −2.6 |
| Armhole | | 18.250 | 17.750 | −2.7 |
| Neck | along seam relaxed | 20.250 | 20.000 | −1.2 |
| Opening | stretched | 44.000 | 44.000 | 0.0 |
| Girdle: | | | | |
| Waist | relaxed | 30.750 | 28.750 | −6.5 |
| stretched | 50.000 | 50.000 | 0.0 | |
| Total Rise | | 28.000 | 27.750 | −0.9 |
| Length | side | 20.875 | 20.625 | −1.2 |
| | inseam | 9.125 | 9.000 | −1.4 |
| Width | crotch | 3.875 | 3.875 | 0.0 |
| | thigh | 18.750 | 18.500 | −1.3 |
| | leg opening | 16.500 | 16.000 | −3.0 |

80° F. Home Wash

| | | | | |
|---|---|---|---|---|
| Shirt: | | | | |
| Length | center front | 21.625 | 21.000 | −2.9 |
| | center back | 26.250 | 26.250 | 0.0 |
| Width | 6″ up from bottom | 37.250 | 36.500 | −2.0 |
| | bottom hem | 37.750 | 36.750 | −2.6 |
| Armhole | | 17.750 | 17.500 | −1.4 |
| Neck | along seam relaxed | 19.750 | 19.750 | 0.0 |
| Opening | stretched | 44.000 | 44.000 | 0.0 |
| Girdle: | | | | |
| Waist | relaxed | 29.500 | 28.750 | −2.5 |
| stretched | 50.000 | 50.000 | 0.0 | |
| Total Rise | | 28.000 | 27.875 | −0.4 |
| Length | side | 21.000 | 20.500 | −2.4 |
| | inseam | 9.000 | 9.000 | 0.0 |
| Width | crotch | 4.000 | 3.875 | −3.1 |
| | thigh | 19.000 | 18.500 | −2.6 |
| | leg opening | 16.750 | 16.000 | −4.5 |

All measurements are in inches.
(−) indicates Loss

Appearance Evaluation After Laundering
USTC CL-5

Eight sets (shirts and girdles) of padded athletic undergarments were laundered by commercial and home laundering methods at various temperatures to determine their performance characteristics. An evaluation of the tested garments revealed the following:

Commercial Washes @ 180° F., 158° F., 120° F., 80° F.

Dimensional change (length and width) of the garments tested was satisfactory at all four temperature washes, although the highest % change was exhibited at the 180° F. wash. High shrinkage of the girdle's elastic waistband was exhibited at the 180° F. and 158° F. washes, although there was no loss of stretch.
No failure of the adhesive bond between the shirt/girdle fabric and the hex pads occurred in any of the four laundering methods. The hexagonal foam pads also remained bonded to their backing fabric.
In all four laundering methods, the garments (shirts and girdles) exhibited good shape retention and appearance. There was no deterioration of seams or fabric and no pilling or fuzziness evident on the fabric surface.
Colorfastness at 180° F. was unsatisfactory. Color change was severe. The grey fabric turned a light green. Colorfastness at 120° F. and 80° F. was satisfactory.
Color change was also considerable at 158° F., although not as severe as at 180° F. The grey fabric turned a grey-green color. (Refer to colorfastness test results that follow and the colorfastness swatches and tested garments returned with this report.)
   Home Laundering @140° F., 120° F., 105° F., 80° F.
Dimensional change (length and width) of all garments tested was satisfactory at all four temperature washes, although lower % dimensional change occurred in the 120° F., 105° F. and 80° F. washes. Lower shrinkage of the girdle's elastic waistband occurred at the 105° F. and 80° F. washes.
No failure of the adhesive bond between the shirt/girdle fabric and the hexagonal foam pads occurred in any of the four laundering methods. The hex pads also remained bonded to their backing fabric.
In all four laundering methods, the garments (shirts and girdles) exhibited good shape retention and appearance. There was no deterioration of seams or fabric and no pilling or fuzziness evident on the fabric surface.

Colorfastness at all four laundering temperatures was satisfactory.

Colorfastness to Commercial Laundering
AATCC 96-2001 as reference

| | Rating @ Wash Temperature | | | |
|---|---|---|---|---|
| | 180° F. | 158° F. | 120° F. | 80° F. |
| Color Change | 1.0 | 2.5 | 4.0 | 4.0 |
| Staining on Multifiber: | | | | |
| Acetate | 3.5 | 4.0 | 4.5 | 4.5 |
| Cotton | 4.5 | 4.5 | 5.0 | 5.0 |
| Nylon | 1.5 | 3.0 | 3.5 | 4.5 |
| Polyester | 4.0 | 4.5 | 4.5 | 4.5 |
| Acrylic | 4.5 | 5.0 | 5.0 | 5.0 |
| Wool | 3.0 | 4.5 | 4.5 | 4.5 |

Colorfastness to Home Laundering
AATCC 150-2003

| | Rating @ Wash Temperature | | | |
|---|---|---|---|---|
| | 140° F. | 120° F. | 105° F. | 80° F. |
| Color Change | 4.0 | 4.5 | 4.5 | 4.5 |
| Staining on Multifiber: | | | | |
| Acetate | 4.5 | 4.5 | 4.5 | 4.5 |
| Cotton | 5.0 | 5.0 | 5.0 | 5.0 |
| Nylon | 4.5 | 4.5 | 4.5 | 4.5 |
| Polyester | 4.5 | 4.5 | 4.5 | 4.5 |
| Acrylic | 5.0 | 5.0 | 5.0 | 5.0 |
| Wool | 4.5 | 4.5 | 4.5 | 4.5 |

Colorfastness Key to Grade Rating
Grade 5 - Negligible or no color change or staining
Grade 4 - Slight or negligible color change or staining
Grade 3 - Noticeable color change or staining
Grade 2 - Considerable color change or staining
Grade 1 - Much color change or staining
The above grade ratings were determined through the use of the AATCC Gray Scales for evaluating color change

Colorfastness to Chlorine & Non-Chlorine Bleaches
USTC CL - 1 & CL - 2

| | Color Change Rating |
|---|---|
| Chlorine Bleach-Spot Test | 2.0 |
| Non-Chlorine Bleach Soak Test | 4.0 |
| | (darker) |

Colorfastness Key to Grade Rating
Grade 5 - Negligible or no color change
Grade 4 - Slight or negligible color change
Grade 3 - Noticeable color change
Grade 2 - Considerable color change
Grade 1 - Much color change
The above grade ratings were determined through the use of the AATCC Gray Scales for evaluating color change

1. A flexible material comprising:
an stretchable fabric substrate; and
a plurality of spaced separate resilient foam elements adhesively affixed to the fabric substrate, the foam elements having a surface which interfaces with the fabric and which surface has an area not greater than 1 square inch, the adhesive comprising a thermoplastic adhesive having a melting point of at least about 250° F.

2. The flexible material as recited in claim 1 wherein the melting range temperature of the adhesive is 250° F. to 265° F.

3. The flexible material as recited in claim 2 wherein the bond line temperature for the adhesive is at least 265° F.

4. The flexible material as recited in claim 1 wherein the flexible material may be exposed at least once to water having a temperature of 212° F., without the material losing any of its foam elements.

5. The flexible material as recited in claim 1 wherein the thermoplastic adhesive includes a component selected from the group consisting of polyethylene, ethyl vinyl acetate and mixtures thereof.

6. The flexible material as recited in claim 5 wherein the thermoplastic adhesive has a melt range temperature of 250 to 265° F. and a bond line temperature of at least 285° F.

7. The flexible material as recited in claim 6 wherein the flexible material may be exposed at least once to water having a temperature of 212° F., without the material losing any of its foam elements.

8. The flexible material as recited in claim 1 wherein the thermoplastic adhesive includes a polyethylene component, has a melting range of 250° F. to 265° F., a minimum bond line temperature of 265° F.

9. The flexible material as recited in claim 8 wherein the flexible material may be exposed to water having a temperature of 212° F., without the material losing any of its foam elements.

10. A flexible material comprising:
a top stretchable fabric substrate;
a bottom stretchable fabric substrate; and
a plurality of spaced separate resilient foam elements adhesively affixed to the fabric substrates, the foam elements having a surface which interfaces with the fabric substrates and which surfaces have an area not greater than 1 square inch, the adhesive comprising a thermoplastic adhesive having a melting point of at least about 250° F.

11. The flexible material as recited in claim 10 wherein the flexible material may be exposed at least once to water having a temperature of 212° F., without the material losing any of its foam elements.

12. The flexible material as recited in claim 11 wherein the thermoplastic adhesive includes a component selected from the group consisting of polyethylene, ethyl vinyl acetate and mixtures thereof.

13. The flexible material as recited in claim 12 wherein the thermoplastic adhesive has a melt range temperature of 250 to 265° F. and a bond line temperature of at least 285° F.

14. The flexible material as recited in claim 13 wherein the flexible material may be exposed at least once to water having a temperature of 212° F., without the material losing any of its foam elements.

15. A garment comprising:
a top stretchable fabric layer;
a bottom stretchable fabric layer; and
a plurality of spaced separate resilient foam elements adhesively affixed to the fabric substrate layers, the foam elements having surfaces which interface with the fabric layers and which surfaces have an area not greater than 1 square inch, the adhesive comprising a thermoplastic adhesive having a melting point of at least about 250° F.

16. The garment as recited in claim 15 wherein the melting range temperature of the adhesive is 250° F. to 265° F.

17. The garment as recited in claim 16 wherein the bond line temperature for the adhesive is at least 265° F.

18. The garment as recited in claim 17 wherein the flexible material may be exposed at least once to water having a temperature of 212° F., without the material losing any of its foam elements.

19. The garment as recited in claim 17 wherein the thermoplastic adhesive includes a component selected from the group consisting of polyethylene, ethyl vinyl acetate and mixtures thereof.

20. The garment as recited in claim 18 wherein the thermoplastic adhesive includes a component selected from the group consisting of polyethylene, ethyl vinyl acetate and mixtures thereof.

21. The garment as recited in claim 20 wherein the thermoplastic adhesive has a melt range temperature of 250 to 265° F. and a bond line temperature of at least 285° F.

22. The garment as recited in claim 15 wherein the garment may be washed in water having a temperature of up to 140° F. for up to about 15 minutes and then dried at a temperature of from about 140° F. to about 200° F. for up to about 40 minutes without detachment of foam elements from the fabric after up to 50 washing and drying cycles.

23. The garment as recited in claim 15 wherein foam elements are hexagonal in shape.

24. A garment comprising:
a top four way stretchable fabric layer which is capable of stretching at least 50%;
a bottom four way stretchable fabric layer which is capable of stretching at least 50% attached to the top fabric layer; and
a plurality of spaced separate resilient foam elements adhesively affixed to the bottom fabric substrate layer and which are between the top and bottom layers, the foam elements having surfaces which interface with the fabric layers and which surfaces have an area not greater than 1 square inch, the adhesive comprising a thermoplastic adhesive having a melting point of at least about 250° F.

25. The garment as recited in claim 24 wherein the bottom layer is stitched to the top layer.

26. The garment as recited in claim 24 wherein the foam elements are adhesively affixed to the top layer.

27. The garment as recited in claim 24 wherein the melting range temperature of the adhesive is 250° F. to 265° F.

28. The garment as recited in claim 24 wherein the garment may be washed in water having a temperature of up to 140° F. for up to about 15 minutes and then dried at a temperature of from about 140° F. to about 200° F. for up to about 40 minutes without detachment of foam elements from the fabric after up to 50 washing and drying cycles.

29. The garment as recited in claim 24 wherein the bond line temperature for the adhesive is at least 265° F.

30. The garment as recited in claim 24 wherein the garment may be exposed at least once to water having a temperature of 212° F., without the material losing any of its foam elements.

31. The garment as recited in claim 24 wherein the thermoplastic adhesive includes a component selected from the group consisting of polyethylene, ethyl vinyl acetate and mixtures thereof.

32. The garment as recited in claim 24 wherein the four way stretch fabric of the top and bottom layers is capable of stretching from 50% to 200%.

33. The garment as recited in claim 25 wherein the foam elements are adhesively affixed to the top layer.

34. The garment as recited in claim 25 wherein the melting range temperature of the adhesive is 250° F. to 265° F.

35. The garment as recited in claim 26 wherein the melting range temperature of the adhesive is 250° F. to 265° F.

36. The garment as recited in claim 26 wherein the garment may be washed in water having a temperature of up to 140° F. for up to about 15 minutes and then dried at a temperature of from about 140° F. to about 200° F. for up to about 40 minutes without detachment of foam elements from the fabric after up to 50 washing and drying cycles.

37. The garment as recited in claim 26 wherein the thermoplastic adhesive includes a component selected from the group consisting of polyethylene, ethyl vinyl acetate and mixtures thereof.

38. The garment as recited in claim 29 wherein the garment may be washed in water having a temperature of up to 140° F. for up to about 15 minutes and then dried at a temperature of from about 140° F. to about 200° F. for up to about 40 minutes without detachment of foam elements from the fabric after up to 50 washing and drying cycles.

39. The garment as recited in claim 33 wherein the melting range temperature of the adhesive is 250° F. to 265° F.

40. The garment as recited in claim 33 wherein the garment may be washed in water having a temperature of up to 140° F. for up to about 15 minutes and then dried at a temperature of from about 140° F. to about 200° F. for up to about 40 minutes without detachment of foam elements from the fabric after up to 50 washing and drying cycles.

41. The garment as recited in claim 40 wherein the thermoplastic adhesive includes a component selected from the group consisting of polyethylene, ethyl vinyl acetate and mixtures thereof.

42. The garment as recited in claim 24 wherein the bond line temperature for the adhesive is at least 265° F.

43. The garment as recited in claim 42 wherein foam elements are hexagonal in shape.

44. A garment comprising:
a top four way stretchable fabric layer which is capable of stretching at least 50%;
a bottom four way stretchable fabric layer which is capable of stretching at least 50%, stitched to the top layer; and
a plurality of spaced separate resilient foam elements adhesively affixed to the bottom and top fabric layers and which are between the top and bottom layers, the foam elements having surfaces which interface with the fabric layers and which surfaces have an area not greater than 1 square inch, the adhesive comprising a thermoplastic adhesive having a melting point of at least about 250° F., the thermoplastic adhesive including a component selected from the group consisting of polyethylene, ethyl vinyl acetate and mixtures thereof, wherein the garment may be exposed at least once to water having a temperature of 212° F. without the material losing any of its foam elements and wherein the garment may be washed in water having a temperature of up to 140° F. for up to about 15 minutes and then dried at a temperature of from about 140° F. to about 200° F. for up to about 40 minutes without detachment of foam elements from the fabric after up to 50 washing and drying cycles.

45. The garment as recited in claim 44 wherein the melting range temperature of the adhesive is 250° F. to 265° F.

46. The garment as recited in claim 44 wherein the bond line temperature for the adhesive is at least 265° F.
